(19) United States
(12) Patent Application Publication
(10) Pub. No.: US 2026/0139583 A1
(43) Pub. Date: May 21, 2026

(54) MAGNETICALLY OPERATED TELEMETRY TOOL

(71) Applicant: Schlumberger Technology Corporation, Sugar Land, TX (US)

(72) Inventors: Edward Richards, Stonehouse (GB); Olga Panova, Stonehouse (GB); Alexander Hickson, Stonehouse (GB)

(21) Appl. No.: 19/378,659

(22) Filed: Nov. 4, 2025

Related U.S. Application Data
(60) Provisional application No. 63/722,126, filed on Nov. 19, 2024.

(51) Int. Cl. E21B 47/18; H01F 7/20; H01H 36/00

(52) U.S. Cl. CPC E21B 47/18; H01F 7/20; H01H 36/00

(57) ABSTRACT

A downhole tool includes first and second electrical conductors and a relay deployed in and rotationally coupled to a first housing. The first and second electrical conductors are electrically connected to the relay. A solenoid is rotationally coupled with a second housing which is rotationally independent from the first housing. The solenoid is configured to actuate the relay and thereby electrically connect or disconnect the first electrical conductor to or from the second electrical conductor.

### CROSS REFERENCE TO RELATED APPLICATIONS

This application claims the benefit of U.S. Provisional Application Ser. No. 63/722,126 entitled MAGNETICALLY OPERATED TELEMETRY TOOL, filed Nov. 19, 2024, which is incorporated herein by reference in its entirety.

### BACKGROUND

Petroleum drilling operations commonly employ a number of techniques to gather information about the wellbore and the formation through which it is drilled. Such techniques are commonly referred to in the art as measurement while drilling (MWD) and logging while drilling (LWD). MWD and LWD techniques may be used, for example, to obtain information about the wellbore (e.g., information about the size, shape, and direction thereof) and the properties of the surrounding formation (e.g., the density, porosity, and resistivity thereof which may be related to the hydrocarbon bearing potential). Transmission of data from a downhole tool in the drill string to the surface is a difficulty common to many MWD and LWD operations.

Mud siren telemetry is commonly used to transmit data from a downhole tool in a wellbore to a receiver at the surface. Mud siren techniques commonly encode a very low frequency (VLF) carrier signal, for example, via phase shift keying or frequency shift keying modulation techniques. Mud siren telemetry commonly utilizes a rotary pulser in a rotor/stator mechanism that periodically restricts the flow of drilling fluid in the bottom hole assembly to generate the carrier signal. The carrier signal may be encoded, for example, via modulating the rotation rate of the rotor via electromagnetic braking. The modulated carrier signal may be detected at the surface, for example, via one or more pressure transducers deployed in the standpipe and decoded to receive the transmitted data.

Downhole tools commonly include sections or housings that rotate independently, such as a roll stabilized housing (or geostationary housing) in a drill collar. It is often desirable to transmit data or power from one rotationally independent section to another. For example, data is commonly collected in a roll stabilized housing of a rotary steerable tool and transmitted to another tool in the bottom hole assembly (or even to the surface). There is a need for improved communication between rotationally independent downhole tool platforms (e.g., in rotary steerable systems).

### SUMMARY

In one example embodiment, a downhole tool includes first, and second electrical conductors and a relay deployed in and rotationally coupled to a first housing. The first and second electrical conductors are electrically connected to the relay. A solenoid is rotationally coupled with a second housing which is rotationally independent from the first housing. The solenoid is configured to actuate the relay and thereby electrically connect or disconnect the first electrical conductor to or from the second electrical conductor.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including a disclosed mud siren telemetry tool;

FIG. 2 is one example embodiment of a disclosed telemetry tool coupled with a rotary steerable tool;

FIG. 3 depicts an example three-phase alternator;

FIGS. 4A and 4B (collectively FIG. 4) depict one embodiment of the telemetry tool shown on FIG. 2 in which a magnetically actuated relay is in a first bias induced axial position (4A) and a second solenoid actuated induced axial position (4B);

FIGS. 5A and 5B (collectively FIG. 5) depict schematic circuit diagrams corresponding to the first and second relay positions shown in FIG. 4;

FIGS. 6A and 6B (collectively FIG. 6) depict another tool embodiment in which a magnetically actuated relay is in a first bias induced axial position (6A) and a second solenoid actuated induced axial position (6B); and

FIGS. 7A and 7B (collectively FIG. 7) depict flowcharts of example methods for modulating a mud siren telemetry signal.

### DETAILED DESCRIPTION

In one example embodiment, a downhole tool includes first and second electrical conductors and a relay deployed in and rotationally coupled to a first housing. The first and second electrical conductors are electrically connected to the relay. A solenoid is rotationally coupled with a second housing which is rotationally independent from the first housing. The solenoid is configured to actuate the relay and thereby electrically connect or disconnect the first electrical conductor to or from the second electrical conductor.

In another example embodiment, a downhole telemetry system has a housing including a drilling fluid flow channel and a shaft deployed in the flow channel and configured to rotate in the housing. An impeller is rotationally coupled to the shaft such that flowing drilling fluid in the flow channel rotates the shaft. A rotary modulator is configured to generate a telemetry carrier signal in the flowing drilling fluid. An alternator is coupled to the shaft, the alternator including a plurality of windings. a relay deployed in the housing and configured to short the plurality of windings to one another when actuated and thereby provide a rotary braking force that modulates the telemetry carrier signal. An electromagnetic actuator is configured to selectively actuate the relay.

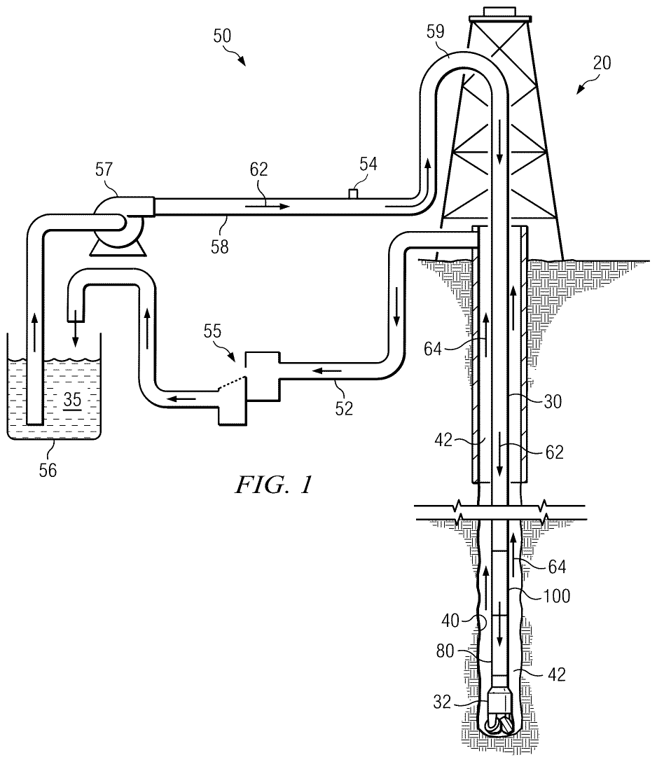

FIG. 1 depicts an example drilling rig 20 including a disclosed magnetically operated mud telemetry tool 100 (e.g., a mud siren telemetry tool). As described in more detail below, the telemetry tool 100 includes a magnetically actuated rotary pulser configured to transmit a modulated telemetry signal to the surface. The drilling rig 20 may be positioned over a subterranean formation (not shown). The rig 20 may include, for example, a derrick and a hoisting apparatus (also not shown) for raising and lowering a drill string 30, which, as shown, extends into wellbore 40 and includes, for example, a drill bit 32 and telemetry tool 100. The drill string 30 may include various other tools, for example, including a downhole drilling motor, a steering tool such as a rotary steerable (RSS) tool 80 or a bent sub, and one or more MWD and/or LWD tools including various sensors for sensing downhole characteristics of the wellbore and the surrounding formation (none of which are shown for simplicity of depiction). The disclosed embodiments are not limited with regards to these other tools in the drill string.

Drilling rig 20 further includes a surface system 50 for controlling the flow of drilling fluid used on the rig (e.g., used in drilling the wellbore 40). In the example rig depicted, drilling fluid 35 is pumped downhole (as depicted at 62), for example, via a conventional mud pump 57. The drilling fluid 35 may be pumped, for example, through a standpipe 58 and mud hose 59 in route to the drill string 30. The drilling fluid 35 typically emerges from the drill string 30 at or near the drill bit 32 and creates an upward flow 64 of mud through the wellbore annulus 42 (the annular space between the drill string and the wellbore wall). The drilling fluid 35 then flows through a return conduit 52 and solids control equipment 55 to a mud pit system 56 where the drilling fluid may be recirculated. It will be appreciated that the terms drilling fluid and mud are used synonymously herein.

With continued reference to FIG. 1, telemetry tool 100 may be configured, for example, to be magnetically actuated by another tool, such as an MWD tool, an LWD tool, or an RSS tool. In such embodiments, the MWD tool, LWD tool, or RSS tool may prepare data for transmission, for example, via filtering, compressing, encoding, and/or digitizing the data. The encoding and digitizing may include, for example, any suitable modulation method to superimpose a digital bit pattern on a carrier wave, for example, phase shift keying (PSK), quadrature phase shift keying (QPSK), frequency shift keying, continuous phase modulation, quadrature amplitude modulation, orthogonal frequency division multiplexing, and the like. The MWD tool, LWD tool, or RSS tool may then further magnetically actuate the telemetry tool to encode the data in a modulated telemetry signal. The disclosed embodiments are, of course, not limited to any particular data preparation or encoding methods.

The telemetry tool 100 may include one or more valves (e.g., a rotary valve or a rotor) to create pressure pulses in the drilling fluid. For example, the telemetry tool 100 may include a rotary pulser or a rotary disc valve pulser that is rotated relative to a stator. In example embodiments, the rotor and stator may each include at least one aperture (window) that permits fluid flow when rotationally aligned (opened) and restrict fluid flow when rotationally misaligned (closed). In other example embodiments, the rotor may include blades that restrict fluid flow when rotationally aligned with stator apertures (closed) and permit fluid flow when rotationally misaligned with the apertures (opened). In such example embodiments, rotation of the rotor periodically restricts the flow of drilling fluid (via periodic alignment and misalignment of the rotor and stator) and thereby generates a positive pressure signal in the downwardly flowing drilling fluid 62 such that rotation of the rotor generates the carrier signal. The carrier signal may be modulated via modulating the rotation rate of the rotor (e.g., via providing a braking action as described in more detail below).

With still further reference to FIG. 1, the modulated telemetry signals propagate to the surface in the downwardly flowing drilling fluid 62 and may be received, for example, via one or more pressure transducers 54 deployed on the standpipe 58. While not depicted on FIG. 1 it will be appreciated that conventional drilling rigs commonly further include a pulsation dampener (a desurger) that evens out the flow in the standpipe 58 and tends to improve the signal to noise ratio of the transmitted telemetry signal. The disclosed embodiments are not limited to the use of such a pulsation dampener.

It will of course be appreciated that while FIG. 1 depicts a land rig 20, that the disclosed embodiments are equally well suited for land rigs or offshore rigs. As is known to those of ordinary skill, offshore rigs commonly include a platform deployed atop a riser that extends from the sea floor to the surface. The drill string extends downward from the platform, through the riser, and into the wellbore through a blowout preventer (BOP) located on the sea floor. The disclosed embodiments are expressly not limited in these regards.

FIG. 2 schematically depicts one example embodiment of telemetry tool 100 deployed in a drill string and coupled with the uphole end of an RSS tool 80 (e.g., the PowerDrive® available from SLB). The example embodiment depicted includes an inner housing 110 deployed in the tool collar 102 and defining an inner fluid passageway 112 that is configured to receive the downward flow of drilling fluid 62. In the depicted example embodiment, a stator 115 (e.g., including stator blades) is deployed at the uphole end of the housing 110 (e.g., carried by or coupled to the housing). A drive shaft 120 may be centrally deployed in and configured to rotate with respect to the housing 110 (e.g., via sealing bearings which are not shown). The shaft 120 may be rotationally coupled with a turbine impeller 122 and a rotor 125. The rotor 125 may be deployed upstream of the stator 115 and may cooperate therewith to generate the telemetry carrier signal (e.g., as described above). A downstream end of the shaft 120 is coupled with an alternator 130, for example, via a gear train or gearbox (not shown).

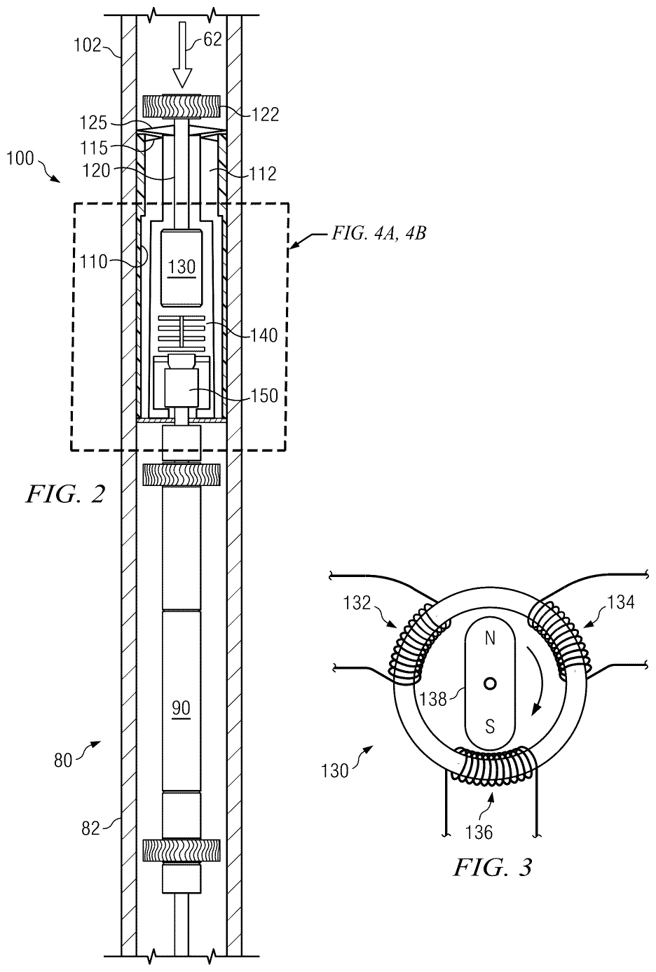

With further reference now to FIG. 3, the alternator 130 may include, for example, a three-phase alternator having three circumferentially spaced stator windings 132, 134, and 136 and a permanent magnet rotor 138. Electrical power is generated via rotating the rotor 138 to rotate the magnetic field emanating from the rotor 138 across the fixed (nonrotating) stator windings 132, 134, and 136. While not depicted, it will be understood that the rotor 138 is rotationally coupled to the shaft 120 which is driven by the flow 62 of drilling fluid through the turbine impeller 122. The stator windings 132, 134, and 136 are also electrically coupled to a magnetically actuated relay 140 (FIG. 2) that is configured to selectively short the windings 132, 134, and 136 so as to electromagnetically brake rotation of the rotor 138, shaft 120, and rotor 125. In the depicted example embodiments, the stator windings 132, 134, and 136 are shorted when the relay is magnetically actuated.

With still further reference to FIG. 2, the telemetry tool 100 further includes an electromagnetic actuator 150, for example, including a solenoid that is configured to magnetically actuate the relay 140 and short the stator windings 132, 134, and 136. In the depicted example embodiments, the electromagnetic actuator 150 is rotationally coupled with the roll stabilized housing 90 of the RSS tool 80. Those of ordinary skill in the art will readily appreciate that certain RSS tools 80 may include a roll stabilized housing 90 that is deployed in and rotationally independent from the RSS tool collar 82 (it will be appreciated that the rotation is about a longitudinal or cylindrical axis of the tool string). In the depicted example embodiment, the telemetry tool 100 (including the housing 110, the shaft 120, the alternator 130, and the magnetic relay 140) is rotationally coupled with the collar 102 and therefore rotates independently with respect to the electromagnetic actuator 150.

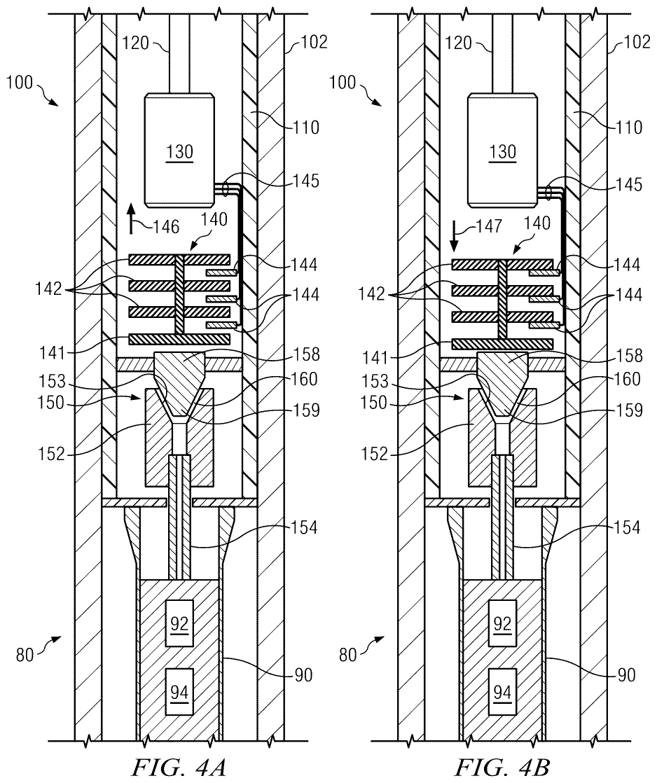

Turning now to FIGS. 4A and 4B (collectively FIG. 4), example embodiments of the magnetically actuated relay 140 and the electromagnetic actuator 150 are described in more detail. In the depicted example embodiment, the magnetically actuated relay 140 and the electromagnetic actuator 150 are deployed in housing 110 and collar 102. Moreover, a solenoid 152 in the electromagnetic actuator is rotationally coupled to the roll stabilized housing 90 and the relay 140 is rotationally coupled with the telemetry tool 100 and the collar 102. In the depicted example embodiments, the solenoid 152 may be rotationally coupled to the roll stabilized housing 90 via shaft 154. The solenoid 152 may be sized and shaped to magnetically engage a magnetic conductor 158 that is rotationally coupled with the telemetry tool 100. The magnetic conductor 158 may include substantially any suitable magnetically permeable material, for example, including a steel alloy, a nickel alloy, or any other type of magnetic material, such as a rare-earth magnet (e.g., neodymium or samarium alloy magnets). In the depicted example, the magnetic conductor 158 may include a conical protrusion 159 that engages a corresponding conical recess 153 in the solenoid 152 (although the disclosed embodiments are of course not limited in this regard).

The engagement between the solenoid 152 and the magnetic conductor 158 may advantageously be a noncontact engagement such that a gap 160 is maintained therebetween. The gap 160 may have substantially any suitable width, for example, in a range from about 0.1 mm to about 10 mm (such as a few mm). The use of a noncontact engagement (a gap) may advantageously reduce the number of physical connections (such as a slip ring) between roll stabilized housing 90 and the telemetry tool 100 and may therefore reduce wear and improve service life and system reliability. The noncontact engagement may still further advantageously reduce drag torque and may further allow for thermal expansion and/or protection from contact during vibration or other relative movement of the solenoid 152 and the magnetic conductor 158.

The gap 160 may be filled with substantially any fluid (including gaseous fluids and liquid fluids). For example, the gap may be filled with air or an inert gas such as nitrogen or argon. Moreover, the gap may include a vacuum or near vacuum. In alternative embodiments, the gap 160 may be filled with an aqueous based fluid such as water or a water-based drilling fluid. Moreover, the gap 160 may be filled with an oil-based fluid such as hydraulic fluid or an oil-based drilling fluid. The disclosed embodiments are, of course, not limited in these regards.

With continued reference to FIGS. 4A and 4B, the magnetic relay 140 may include a moveable contact portion including a magnetically permeable material 141 and a plurality of movable contacts 142 and a stationary section including a corresponding plurality of stationary contacts 144. The magnetically permeable material 141 and the movable contacts 142 are configured to translate between first and second axial positions. In the depicted example embodiment, the movable contacts are biased (e.g., spring biased) axially away from the magnetic conductor 158 as indicated at 146 towards the first axial position (FIG. 4A). The movable contacts 142 may be biased using substantially any suitable biasing mechanism, for example, including a hydraulic or pneumatic piston, a spring, a Belleville washer, and the like. The disclosed embodiments are not limited to any particular biasing mechanism. In the first axial position, the movable contacts 142 are physically and electrically separated from the stationary contacts 144 such that there is no electrical connectivity therebetween. The movable contacts remain biased in the first axial position unless acted upon by the solenoid 152.

With reference to FIG. 4B, in the depicted example embodiments, actuation of the solenoid 152 attracts the magnetically permeable material 141 such that the movable contacts 142 move against the bias as indicated at 147 towards the solenoid 152 and the depicted second axial position. In the second axial position, the movable contacts 142 are electrically coupled with (e.g. in physical contact with) the stationary contacts 144. The stationary contacts 144 are electrically connected to the alternator 130 as depicted collectively at 145, for example, with each stationary contact connected to a distinct alternator winding. The electrical connection between the movable contacts 142 and the stationary contacts 144 therefore electrically shorts the stator windings 132, 134, and 136 (FIG. 3) in alternator 130 thereby providing the above-described braking action. The movable contacts remain in the second axial position when the solenoid is actuated and return (via the bias) to the first position when the solenoid is no longer actuated (de-actuated).

It will be appreciated that the disclosed embodiments are not limited to embodiments in which actuation of the solenoid 152 attracts the movable contacts to make contact with the stationary contacts (e.g., as depicted in FIGS. 4A and 4B). In alternative embodiments (not depicted), the solenoid may be configured to break contact between the moveable contacts and the stationary contacts. For example, in such alternative embodiments the moveable contacts may be biased into contact with the stationary contacts and actuation of the solenoid may attract the moveable contacts away from the stationary contact thereby breaking the contact.

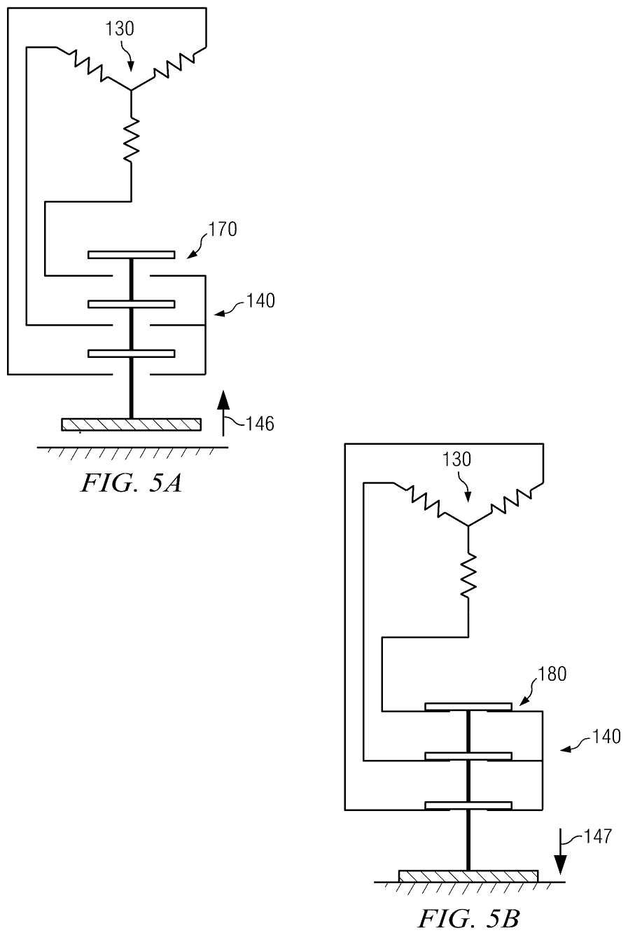

FIGS. 5A and 5B depict schematic circuit diagrams. In FIG. 5A, the movable contacts are biased to the first position as indicated at 146 such that there is no electrical contact between the movable contacts and the stationary contacts as indicated at 170. In FIG. 5B, the movable contacts are actuated to the second position as indicated at 147 such that the movable contacts are in electrical contact with the stationary contacts as indicated at 180 thereby shorting the first, second, and third phases of the alternator 130 to one another. As described above, this short circuit provides the braking action to the rotor in the mud siren thereby modulating the carrier frequency.

With reference again to FIG. 4, repeated actuation of the solenoid 152 may be employed to modulate a telemetry carrier signal and thereby transmit data (or other information) to the surface. In the depicted example embodiments, the rotary steerable tool 80 may include one or more sensors 94, such as an MWD survey sensors, configured to make sensor measurements while drilling. The sensor measurements may be processed using a controller or processor 92 to prepare them for transmission, for example, via filtering, compressing, encoding, and/or digitizing. The encoding and digitizing may include, for example, any suitable modulation method to superimpose a digital bit pattern on a carrier wave, for example, employing PSK or FSK modulation. The controller 92 may be further configured to repeatedly actuate and de-actuate the solenoid 152 such that the modulated telemetry signal is encoded with the prepared sensor measurements. In this way, data collected in the roll stabilized housing may be transmitted to the surface by advantageously using a telemetry tool 100 that is rotationally coupled with the tool collar.

While the disclosed embodiments are described above with respect to a rotary steerable embodiment, it will be appreciated that the disclosure is not so limited. For example, telemetry tool 100 may be employed with substantially any suitable downhole tool including a platform that is rotationally independent therefrom. Such other tools may include, for example, MWD tools, LWD tools, and the like. Moreover, it will be appreciated that the disclosed embodiments are not limited to employment in a telemetry operation (e.g., mud siren or mud pulse telemetry). The disclosed embodiments may be advantageously utilized to actuate the making and breaking electrical connection(s) in a first tool platform from a rotationally independent second tool platform.

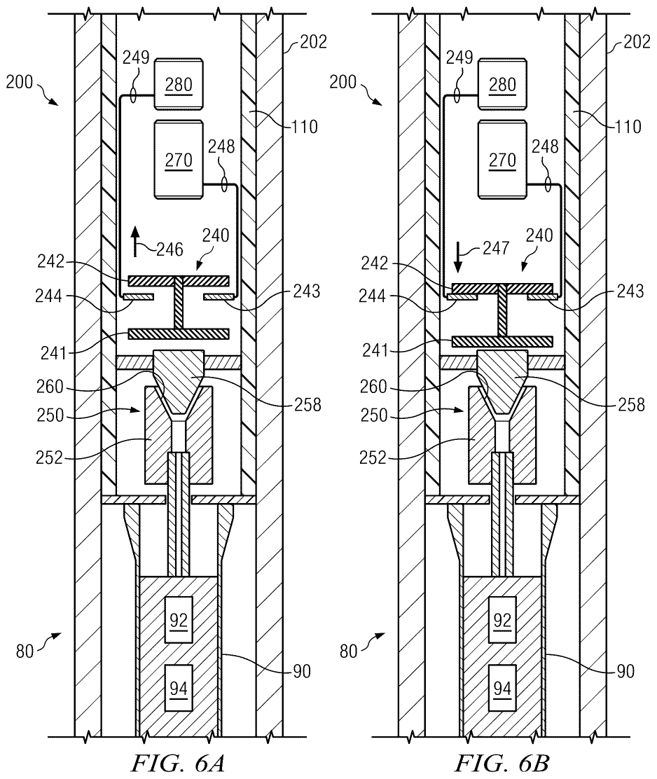

FIGS. 6A and 6B (collectively FIG. 6) depict another example embodiment of a magnetically actuated relay and the electromagnetic actuator in use in a downhole tool. In the depicted example embodiment, downhole tool 200 is coupled to a rotary steerable tool 80 (or other tool) including a roll stabilized housing 90 having a controller 92 and a sensor 94. A magnetically actuated relay 240 and an electromagnetic actuator 250 are deployed in a drill collar 202. A solenoid 252 in the electromagnetic actuator 250 is rotationally coupled to the roll stabilized housing 90 and the relay 240 is rotationally coupled with tool 200 and collar 202. In the depicted example embodiments, the solenoid 252 may be sized and shaped to magnetically engage a magnetic conductor 258 that is rotationally coupled with the tool 200 (e.g., as described above with respect to FIG. 4). The engagement between the solenoid 252 and the magnetic conductor 258 may advantageously include a noncontact engagement such that a gap 260 is maintained therebetween. The gap may be as described above with respect to FIG. 4.

With continued reference to FIG. 6, the relay 240 may include a moveable contact portion including a magnetically permeable material 241 and a movable contact 242 and a stationary section including plurality of stationary contacts 243, 244. The magnetically permeable material 241 and the movable contact 242 are configured to translate between first and second axial positions. In the depicted example embodiment, the movable contact is biased (e.g., spring biased) axially away from the magnetic conductor 258 as indicated at 246 towards the first axial position (FIG. 6A). In the first axial position, the movable contact 242 is physically and electrically separated from the stationary contacts 243, 244 such that there is no electrical connectivity therebetween. The movable contact remains biased in the first axial position unless acted upon by the solenoid 252.

With reference to FIG. 6B, in the depicted example embodiments, actuation of the solenoid 252 attracts the magnetically permeable material 241 such that the movable contact 242 moves against the bias as indicated at 247 towards the solenoid 252 and the depicted second axial position. In the second axial position, the movable contact 242 is electrically coupled with (e.g. in physical contact with) the stationary contacts 243, 244 such that a first electrical conductor 248 is electrically connected with a second electrical conductor 249. In this way, first and second devices 270 and 280 in tool 200 may be electrically connected to one another via actuation from a controller 92 in the rotationally independent platform 90.

The first and second devices 270 and 280 may include substantially any suitable devices that may be electrically connected to one another. For example, the first device 270 may be a power source such as a battery and the second device 280 may be a device that requires intermittent power, such as a sensor or a transmitter. The second device 280 may also optionally include an insulative gap, for example, between first and second sections of a tool housing or tool collar. In such an embodiment the controller 92 may be further configured to repeatedly actuate and de-actuate the solenoid 252 to generate a series of electrical pulses across the gap and thereby transmit information to another location in the drill string. Moreover, in still other embodiments, power may be supplied to the moveable contact (e.g., via an electrical connection with a power supply) such that making contact with the stationary contacts 243, 244 simultaneously provides power to both the first and second devices 270, 280.

It will be appreciated that the embodiments disclosed in FIG. 6 are not limited to embodiments in which actuation of the solenoid 252 attracts the movable contact to make contact with the stationary contacts (e.g., as depicted in FIGS. 6A and 6B). In alternative embodiments (not depicted), the solenoid may be configured to break contact between the moveable contact and the stationary contacts. For example, in such alternative embodiments the moveable contact may be biased into contact with the stationary contacts and actuation of the solenoid may attract the moveable contacts away from the stationary contact thereby breaking the contact.

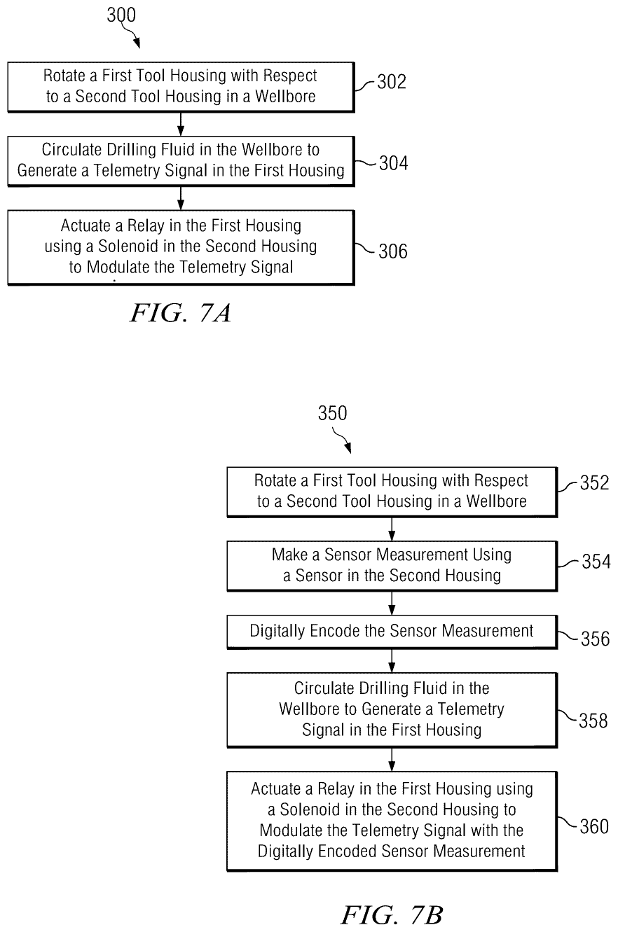

With reference again to FIGS. 2-4 and further reference to FIGS. 7A and 7B (collectively FIG. 7), flowcharts of example methods for modulating a mud siren telemetry signal are depicted. In FIG. 7A, method 300 includes rotating a first tool housing or tool collar with respect to a second tool housing or roll stabilized housing in a wellbore at 302 (e.g., rotating collar 102 with respect to roll stabilized housing 90). Drilling fluid is circulated through the tool string to generate a telemetry signal in the first housing at 304, for example, using the telemetry tool 100 deployed in and rotationally coupled with the collar 102. As described above, the circulating drilling fluid may rotate shaft 120 and rotor 125 to generate a carrier signal in the drilling fluid. A relay located in and rotationally coupled with the first tool housing may be actuated using a solenoid that is rotationally coupled with the second tool housing to modulate the telemetry signal. Actuation of the relay via the solenoid may short alternator windings 132, 134, and 136, thereby providing a braking force on the shaft 122 to modulate the carrier signal (e.g., modulate the frequency).

In FIG. 7B, method 350 is similar to method 300 in that a first tool housing is rotated with respect to a second tool housing in a wellbore at 352. Sensor measurements are made at 354 using a sensor deployed in and rotationally coupled with the second housing. The sensor may be deployed, for example, in a roll stabilized housing of a rotary steerable drilling system as described above. The sensor measurements (or a selected set of the sensor measurements) may be digitally encoded at 356 using a processor located in the second housing (e.g., a processor or controller located in the roll stabilized housing of the rotary steerable drilling system). Drilling fluid is circulated through the tool string, for example, while rotating at 352, to generate a telemetry signal in the first housing at 358. A relay in the first housing may be repeatedly actuated using a solenoid that is rotationally coupled with the second housing to modulate the telemetry signal with the digitally encoded sensor measurements at 360.

It will be understood that the present disclosure includes numerous embodiments. These embodiments include, but are not limited to, the following embodiments.

In a first embodiment, a downhole telemetry system comprises a housing including a drilling fluid flow channel; a shaft deployed in the flow channel and configured to rotate in the housing; an impeller rotationally coupled to the shaft such that flowing drilling fluid in the flow channel rotates the shaft; a rotary modulator configured to generate a telemetry carrier signal in the flowing drilling fluid; an alternator coupled to the shaft, the alternator including a plurality of windings; a relay deployed in the housing and configured to short the plurality of windings to one another when actuated and thereby provide a rotary braking force that modulates the telemetry carrier signal; and an electromagnetic actuator configured to selectively actuate the relay.

A second embodiment may include the first embodiment, wherein the rotary modulator comprises a rotor rotationally coupled to the shaft; and a stator proximate to the rotor and coupled with the housing such that rotation of the rotor generates the telemetry carrier signal.

A third embodiment may include any one of the first through second embodiments, wherein the relay is rotationally coupled with the housing; and the electromagnetic actuator comprises a solenoid that is rotationally independent from the relay.

A fourth embodiment may include any one of the first through third embodiments, wherein the telemetry system is operatively coupled with a rotary steerable system; the housing is rotationally coupled with a drill collar; the relay is rotationally coupled with the housing; and the electromagnetic actuator includes a solenoid that is rotationally coupled with a roll stabilized housing deployed in the rotary steerable system, the roll stabilized housing is rotationally independent from drill collar.

A fifth embodiment may include any one of the first through fourth embodiments, wherein the alternator comprises three windings; and the relay comprises a three pole relay.

A sixth embodiment may include any one of the first through fifth embodiments, wherein the relay comprises a plurality of stationary contacts that are electrically connected to the corresponding plurality of windings; and a plurality of movable contacts that are configured to make contact with the stationary contacts and thereby short the plurality of windings when the relay is actuated.

A seventh embodiment may include the sixth embodiment, wherein the plurality of movable contacts are configured to move between first and second axial positions; the plurality of movable contacts are biased towards the first position; and actuation of the relay moves the plurality of movable contacts to the second position against the bias and thereby short the plurality of windings.

An eighth embodiment may include the seventh embodiment, wherein the electromagnetic actuator comprises a solenoid; and the relay comprises a magnetically permeable material that is coupled with the moveable contacts such that the moveable contacts move from the first position to the second position when the solenoid is actuated.

A ninth embodiment may include the eighth embodiment, further comprising a magnetic conductor deployed between the solenoid and the magnetically permeable member in the relay, the magnetic conductor configured to rotate with the first housing such that it is rotationally independent from the solenoid.

A tenth embodiment may include any one of the sixth through ninth embodiments, wherein actuation of the solenoid moves the plurality of movable contacts towards the solenoid into contact with the corresponding plurality of stationary contacts.

In an eleventh embodiment, a method for modulating a downhole telemetry signal comprises rotating a downhole tool in a wellbore to rotate a first tool housing with respect to a second tool housing, a mud pulse telemetry tool deployed in the first tool housing; circulating drilling fluid through the downhole tool while rotating to rotate an internal shaft with respect to the first tool housing and thereby cause the mud pulse telemetry tool to generate a telemetry carrier signal; and actuating a solenoid to actuate a relay and thereby modulate the telemetry carrier signal, the relay being rotationally coupled with the first downhole housing and the solenoid being rotationally coupled with the second downhole housing.

A twelfth embodiment may include the eleventh embodiment, wherein the first tool housing is rotationally coupled with a drill collar and operatively coupled with a rotary steerable system; the second tool housing is a roll stabilized housing deployed in the rotary steerable system, the roll stabilized housing is rotationally independent from the drill collar; the relay is deployed in and rotationally coupled with the first housing; and the solenoid is rotationally coupled with the roll stabilized housing.

A thirteenth embodiment may include the twelfth embodiment, wherein the actuating comprises repeated actuation and de-actuation that encodes and transmits rotary steerable system data in the modulated telemetry carrier signal.

A fourteenth embodiment may include any one of the eleventh through thirteenth embodiments, wherein actuating the solenoid causes a moveable contact in the relay to move from a first position to a second position and thereby short a plurality of alternator windings to one another.

A fifteenth embodiment may include the fourteenth embodiment, wherein the shorting the plurality of alternator windings to one another provides a braking action on a rotor shaft and thereby modulates the telemetry carrier signal.

In a sixteenth embodiment, a downhole tool comprises first and second electrical conductors and a relay deployed in and rotationally coupled to a first housing, the first and second electrical conductors electrically connected to the relay; and a solenoid rotationally coupled with a second housing, the second housing rotationally independent from the first housing, the solenoid configured to actuate the relay and thereby electrically connect or disconnect the first electrical conductor to the second electrical conductor.

A seventeenth embodiment may include the sixteenth embodiment, wherein the first housing is rotationally coupled with a drill collar and operatively coupled with a rotary steerable system; the second housing is a roll stabilized housing deployed in the rotary steerable system, the roll stabilized housing rotationally independent from the drill collar; the relay is deployed in and rotationally coupled with the first housing; and the electromagnetic actuator includes a solenoid that is rotationally coupled with the roll stabilized housing.

An eighteenth embodiment may include any one of the sixteenth through seventeenth embodiments, further comprising an electrical power supply deployed in the first housing and electrically connected to the first conductor and an electrically powered device deployed in the first housing and electrically connected to the second conductor, wherein actuation of the electromagnetic actuator in the second housing electrically connects the power supply to the electric powered device in the first housing.

A nineteenth embodiment may include any one of the sixteenth through eighteenth embodiments, wherein the relay comprise first and second stationary contacts that are electrically connected to the corresponding first and second electrical conductors; a movable contact configured to move between first and second positions, the first and second stationary contacts being electrically isolated from one another when the movable contact is in the first position and electrically connected to one another when the movable contact is in the second position; wherein the movable contact is biased towards the first position and actuation of the solenoid moves the movable contact to the second position against the bias and thereby electrically connects the first and second electrical conductors.

A twentieth embodiment may include any one of the sixteenth through nineteenth embodiments, further comprising a magnetic conductor deployed between the solenoid and the relay, the magnetic conductor configured to rotate with the first housing such that it is rotationally independent from the solenoid; a fluid filled gap between the magnetic conductor and the solenoid; and wherein the relay comprises a magnetically permeable material that is mechanically coupled with the moveable contact such that the moveable contact moves from the first position to the second position when the solenoid is actuated.

Although a magnetically operated telemetry tool and certain advantages thereof have been described in detail, it should be understood that various changes, substitutions and alterations may be made herein without departing from the spirit and scope of the disclosure.

1. A downhole telemetry system comprising:
a housing including a drilling fluid flow channel;
a shaft deployed in the flow channel and configured to rotate in the housing;
an impeller rotationally coupled to the shaft such that flowing drilling fluid in the flow channel rotates the shaft;
a rotary modulator configured to generate a telemetry carrier signal in the flowing drilling fluid;
an alternator coupled to the shaft, the alternator including a plurality of windings;
a relay deployed in the housing and configured to short the plurality of windings to one another when actuated and thereby provide a rotary braking force that modulates the telemetry carrier signal; and
an electromagnetic actuator configured to selectively actuate the relay.

2. The telemetry system of claim 1, wherein the rotary modulator comprises:
a rotor rotationally coupled to the shaft; and
a stator proximate to the rotor and coupled with the housing such that rotation of the rotor generates the telemetry carrier signal.

3. The telemetry system of claim 1, wherein:
the relay is rotationally coupled with the housing; and
the electromagnetic actuator comprises a solenoid that is rotationally independent from the relay.

4. The telemetry system of claim 1, wherein:
the telemetry system is operatively coupled with a rotary steerable system;
the housing is rotationally coupled with a drill collar;
the relay is rotationally coupled with the housing; and
the electromagnetic actuator includes a solenoid that is rotationally coupled with a roll stabilized housing deployed in the rotary steerable system, the roll stabilized housing is rotationally independent from drill collar.

5. The telemetry system of claim 1, wherein:
the alternator comprises three windings; and
the relay comprises a three pole relay.

6. The telemetry system of claim 1, wherein:
the relay comprises a plurality of stationary contacts that are electrically connected to the corresponding plurality of windings; and
a plurality of movable contacts that are configured to make contact with the stationary contacts and thereby short the plurality of windings when the relay is actuated.

7. The telemetry system of claim 6, wherein:
the plurality of movable contacts are configured to move between first and second axial positions;
the plurality of movable contacts are biased towards the first position; and
actuation of the relay moves the plurality of movable contacts to the second position against the bias and thereby short the plurality of windings.

8. The telemetry system of claim 7, wherein:
the electromagnetic actuator comprises a solenoid; and
the relay comprises a magnetically permeable material that is coupled with the moveable contacts such that the moveable contacts move from the first position to the second position when the solenoid is actuated.

9. The telemetry system of claim 8, further comprising a magnetic conductor deployed between the solenoid and the magnetically permeable member in the relay, the magnetic conductor configured to rotate with the first housing such that it is rotationally independent from the solenoid.

10. The telemetry system of claim 6, wherein actuation of the solenoid moves the plurality of movable contacts towards the solenoid into contact with the corresponding plurality of stationary contacts.

11. A method for modulating a downhole telemetry signal, the method comprising:
rotating a downhole tool in a wellbore to rotate a first tool housing with respect to a second tool housing, a mud pulse telemetry tool deployed in the first tool housing;
circulating drilling fluid through the downhole tool while rotating to rotate an internal shaft with respect to the first tool housing and thereby cause the mud pulse telemetry tool to generate a telemetry carrier signal; and
actuating a solenoid to actuate a relay and thereby modulate the telemetry carrier signal, the relay being rotationally coupled with the first downhole housing and the solenoid being rotationally coupled with the second downhole housing.

12. The method of claim 11, wherein:
the first tool housing is rotationally coupled with a drill collar and operatively coupled with a rotary steerable system;
the second tool housing is a roll stabilized housing deployed in the rotary steerable system, the roll stabilized housing is rotationally independent from the drill collar;
the relay is deployed in and rotationally coupled with the first housing; and
the solenoid is rotationally coupled with the roll stabilized housing.

13. The method of claim 12, wherein the actuating comprises repeated actuation and de-actuation that encodes and transmits rotary steerable system data in the modulated telemetry carrier signal.

14. The method of claim 11, wherein actuating the solenoid causes a moveable contact in the relay to move from a first position to a second position and thereby short a plurality of alternator windings to one another.

15. The method of claim 14, wherein the shorting the plurality of alternator windings to one another provides a braking action on a rotor shaft and thereby modulates the telemetry carrier signal.

16. A downhole tool comprising:
first and second electrical conductors and a relay deployed in and rotationally coupled to a first housing, the first and second electrical conductors electrically connected to the relay; and
a solenoid rotationally coupled with a second housing, the second housing rotationally independent from the first housing, the solenoid configured to actuate the relay and thereby electrically connect or disconnect the first electrical conductor to the second electrical conductor.

17. The downhole tool of claim 16, wherein:
the first housing is rotationally coupled with a drill collar and operatively coupled with a rotary steerable system;
the second housing is a roll stabilized housing deployed in the rotary steerable system, the roll stabilized housing rotationally independent from the drill collar;
the relay is deployed in and rotationally coupled with the first housing; and
the electromagnetic actuator includes a solenoid that is rotationally coupled with the roll stabilized housing.

18. The downhole tool of claim 16, further comprising:
an electrical power supply deployed in the first housing and electrically connected to the first conductor and an electrically powered device deployed in the first housing and electrically connected to the second conductor, wherein actuation of the electromagnetic actuator in the second housing electrically connects the power supply to the electric powered device in the first housing.

19. The telemetry system of claim 16, wherein the relay comprises:
first and second stationary contacts that are electrically connected to the corresponding first and second electrical conductors;
a movable contact configured to move between first and second positions, the first and second stationary contacts being electrically isolated from one another when the movable contact is in the first position and electrically connected to one another when the movable contact is in the second position;
wherein the movable contact is biased towards the first position and actuation of the solenoid moves the movable contact to the second position against the bias and thereby electrically connects the first and second electrical conductors.

20. The telemetry system of claim 16, further comprising:
a magnetic conductor deployed between the solenoid and the relay, the magnetic conductor configured to rotate with the first housing such that it is rotationally independent from the solenoid;
a fluid filled gap between the magnetic conductor and the solenoid; and wherein the relay comprises a magnetically permeable material that is mechanically coupled with the moveable contact such that the moveable contact moves from the first position to the second position when solenoid is actuated.
